(19) United States
(12) Patent Application Publication
(10) Pub. No.: US 2013/0003549 A1
(43) Pub. Date: Jan. 3, 2013

(54) Resilient Hashing for Load Balancing of Traffic Flows

(75) Inventors: Brad MATTHEWS, San Jose, CA (US); Puneet Agarwal, Cupertino, CA (US)

(73) Assignee: Broadcom Corporation, Irvine, CA (US)

(21) Appl. No.: 13/174,511

(22) Filed: Jun. 30, 2011

(51) Int. Cl. H04L 12/26

(52) U.S. Cl. 370/235

(57) ABSTRACT

Methods, systems, and computer program product embodiments for managing traffic flows member of a plurality of available member resources in a communications device are disclosed. Embodiments include configuring a flow table containing a plurality of mappings, where each of the mappings specifies a relationship between one of a range of index values and at least one of the plurality of available member resources of an aggregated resource, assigning using the flow table respective traffic flows to at least one of the plurality of available links, and responsive to a change in the plurality of available member resources, changing the plurality of mappings.

### BACKGROUND OF THE INVENTION

1. Field of the Invention

Embodiments of this invention are related to managing traffic flows in a communication device.

2. Background Art

A pair of communications devices can exchange data and control messages over any number of physical links between them. For example, switches and routers may have multiple links connecting them for increased bandwidth and improved reliability. Multiple communications links between two devices can also be found internally in communications devices. For example, a switch fabric may connect to a network interface card using multiple communications links.

As data transmission requirements increase, it becomes necessary to increase the data transfer capacity between devices such as switches and routers in the end-to-end communications path. It also becomes necessary to accordingly increase data transfer capacity between internal components of communications devices, such as between a switch fabric and a network interface card.

The requirements for increased data transfer capacity can be accommodated by adding higher bandwidth links. Another approach would be to utilize the multiple links that already exist between devices to transfer an increased amount of data in parallel over the respective links connecting those devices.

Link aggregation is a method of logically bundling two or more physical links to form one logical link. The logical link (“aggregated link”) can be considered to have the sum bandwidth or a bandwidth close to the sum bandwidth of the individual links that are bundled. The aggregated link may be considered as a single link by higher-layer protocols (e.g., network layer and above), thus facilitating data transfer at faster rates without the overhead of managing data transfer over separate physical links at the higher-layer protocols. Furthermore, the aggregated link provides redundancy when individual links fail. Typically, link aggregation is implemented at the logical link control layer/media access control layer, which is layer 2 of the Open System Interconnect (OSI) protocol stack.

Relatively recent standards, such as, IEEE 802.3ad and IEEE 802.1ax, have resulted in link aggregation (“LAG”) being implemented in an increasing number of communications devices. Standards such as those mentioned above include a control protocol to coordinate the setting up, tear down, and management of aggregated links. The IEEE-specified “Link Aggregation Control Protocol” (LACP) is an example LAG protocol. Some communications devices may implement LAG techniques other than those specified in the standards.

Equal Cost Multi-Path (ECMP) routing, for example, as specified in RFC 2991-2992, is another approach to transmitting traffic from a switch or router that can be implemented using aggregated links. In the case of ECMP, the aggregated link comprises an aggregation of virtual links. Each virtual link in a particular aggregated link may be configured to the same destination via a different next hop. A routing protocol, such as a layer 3 routing protocol, may direct packets to a destination via any of the physical links configured to reach the destination.

The “Serializer/Deserializer” protocol (“SerDes”) is a commonly used data encoding and transfer method utilizing point-to-point serial links at the physical layer to transfer information between two communications devices or between two components internal to a communications device. SerDes also specifies transferring data in parallel over the multiple links between two devices. A physical port (or physical link) may be referred to herein as a “serdes port (link)” if it is a port or link that operated according to SerDes.

The physical ports or links that are aggregated may include ports configured for Ethernet or other protocols. A physical port or link may be referred to herein as an “ethernet port (link)” if that port or link operates according to the Ethernet protocol.

Herein, the term “aggregated resource” is used to refer to aggregated physical links, aggregated virtual links, aggregated next hops, or other aggregated destination-based resources. An aggregated resource comprises one or more member resources. Accordingly, the term “member resource” refers to a physical link, virtual link, next hop, or other destination-based resource.

Various methods are known to assign incoming traffic flows to respective member resources of an aggregated resource. For example, a hashed flow identifier, where the flow identifier is determined based upon selected header field values of the packets, may be used to assign an incoming flow to one or more of the member resources in the aggregated resource. Various methods are known for load balancing so that the current incoming traffic can be distributed among respective member resources of an aggregated resource, for example, among respective egress physical links of an aggregated link.

When existing member resources are deactivated and/or when new member resources are added to the aggregated resource, it may be necessary to adjust the aggregated resource configuration so that the traffic is properly distributed between the available member resources. However, such adjustments to the aggregated resource configuration can lead to unnecessary disruptions to communications, for example, because of misordering of packets in flows.

A conventional method of distributing incoming traffic flows to respective member resources in an aggregated resource is based upon determining a hash value for an incoming packet where the hash value based on a function such as a modulo function applied to a combination of fields of the incoming packet specifies one of the plurality of available member resources, and then sending the incoming packet to the link corresponding to the hash value. For example, if four member resources are available in the aggregated resource, the member resources (e.g. links) are logically enumerated 0-3 by a function that maps members of an aggregated resource to physical links and each incoming packet is mapped to a value between 0 and 3 and sent to the corresponding member resource. When the number of member resources changes in the aggregated resource, all flows may be reassigned to different member resources because the hash function itself is changed due to the change in the number of available member resources. Indiscriminately affecting traffic flows in this manner may cause unnecessary disruptions, for example, due to misordering of packets and/or loss of packets.

### BRIEF SUMMARY OF THE INVENTION

Embodiments of the present invention are directed to managing traffic flows over multiple links in communication device. According to an embodiment, a method for managing traffic flows over a plurality of available member resources in a communications device includes configuring a flow table containing a plurality of mappings, where each of the mappings specifies a relationship between one of a range of index values and at least one of the plurality of available member resources of an aggregated resource, assigning using the flow table respective traffic flows to at least one of the plurality of available links, and responsive to a change in the plurality of available member resources, changing the plurality of mappings.

Another embodiment is a system for managing traffic flows over a plurality of available member resources in a communications device, including a flow table and a traffic flow mapper. The flow table is configured to contain a plurality of mappings where each of said mappings specifies a relationship between one of a range of index values and at least one of the plurality of available member resources of an aggregated resource. Each index value can correspond to one or more traffic flows. The traffic flow mapper is configured to assign, using the flow table, respective traffic flows to at least one of the plurality of available links, and responsive to a change in the plurality of available member resources, changing the plurality of mappings.

Another embodiment is a computer readable media storing instructions where the instructions when executed are adapted to manage taffic flows over a plurality of available member resources in a communications device. The method includes configuring a flow table containing a plurality of mappings where each mapping specifies a relationship between one of a range of index values and at least one of the plurality of available member resources of an aggregated resource, assigning using the flow table respective traffic flows to at least one of the plurality of available member resources, and responsive to a change in the plurality of available member resources changing the plurality of mappings.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a system comprising a local communications device and a remote communications device coupled by an aggregated resource, according to an embodiment of the present invention.

FIG. 2 illustrates a communications device, according to an embodiment of the present invention.

FIG. 3A illustrates a flow table, according to an embodiment of the present invention.

FIG. 3B illustrates an available member resource list, according to an embodiment of the present invention.

FIG. 4 illustrates a flowchart of an exemplary method for managing traffic flows in a aggregated resource, according to an embodiment of the present invention.

FIG. 5 illustrates a flowchart describing further details of forming a flow table, according to an embodiment of the present invention.

FIG. 6 illustrates a flowchart describing reconfiguring an aggregated resource with a deactivation of a member resource, according to an embodiment of the present invention.

FIG. 7 illustrates a flowchart describing reconfiguring mappings in a flow table, according to an embodiment of the present invention.

FIG. 8 illustrates a flowchart describing the activating of a failover member resource, according to an embodiment of the present invention.

FIG. 9 illustrates a flowchart describing reconfiguring an aggregated resource with a new member resource activation, according to an embodiment of the present invention.

FIG. 10 illustrates a flowchart describing further details of reconfiguring an aggregated resource when a new member resource is activated, according to an embodiment of the present invention.

### DETAILED DESCRIPTION OF THE INVENTION

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

Embodiments disclosed in the specification provide for managing aggregated resources in various communications devices, such as, but not limited to, switches and routers. Specifically, aggregated resources may be managed such that the interruptions due to aggregated resource configuration changes such as the deactivations of currently active links and/or activation of currently inactive links are reduced in end-to-end communication.

A flow table and a hashing for incoming packets and/or flows are disclosed. The flow table is configurable and maintains bindings (i.e. mappings) of groups of one or more flows to specific resources or links. Embodiments disclosed herein limits traffic flow disruption, such as misordering of packets, due to a link deactivation to only those traffic flows that were assigned to the deactivated link. For example, upon a link deactivation, disclosed embodiments enable the reassignment of only those flows which were assigned to the deactivated link, and thereby isolate other traffic flows from effects of the deactivation. Furthermore, embodiments do not require that the hashing function is changed when the link configuration of the aggregated resource is changed. The hashing function is used to find a matching entry for a packet or flow in the flow table, where the matching entry is configured with the link associated with that packet or flow. Because disclosed embodiments do not require that the hash function is changed based on configuration changes of the aggregated resource, the hashing may be considered as resilient when compared to conventional uses of hashing for load balancing applications.

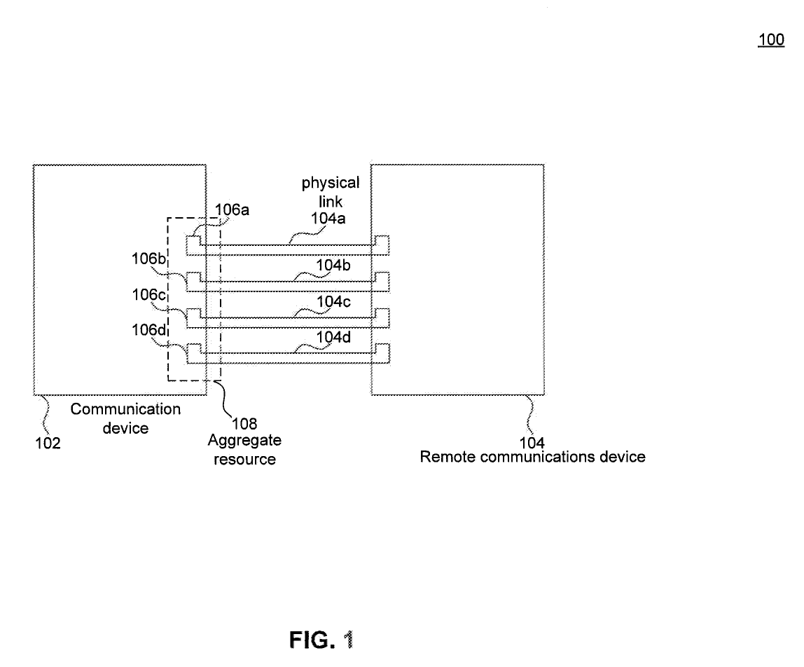

FIG. 1 illustrates an exemplary system 100 according to an embodiment of the present invention. A local communications device 102 and a remote communications device 104 are communicatively coupled using a plurality of physical links 104a-d. The communications devices 102 and 104 can be any type of a communications or computing device. The physical ports associated with the respective physical links 104a-d at the local communications device 102 are referred to as physical ports 106a-d. An aggregated resource 108 may be formed by logically aggregating the physical links 104a-d or a subset thereof. The physical links may be egress physical links. Each of the physical links is sometimes referred to as a “resource.” Correspondingly, the aggregated resource is sometimes referred to as a “resource group” or “aggregate.” A communications device such as a router or a switch may include one or more of these aggregated resources.

In other embodiments, a resource can include an egress (i.e. transmit) interface of communications device 102 (such as SerDes interface (not shown)), a next hop (e.g. respective individual ports in the directly connected device(s)), or any other destination-based resource. Accordingly, a resource group is a collection of such resources. In particular, as used herein, a resource group is a collection of resources over which the aggregate traffic load should be distributed.

The aggregated resource 108 may be formed according to a LAG protocol such as IEEE 802.1ax, IEEE 802.3ad, each of which is incorporated herein by reference, or other LAG protocol. The aggregated resource 108 may utilize an aggregate link protocol such as LACP to control the setting up and managing of the aggregated resource. For example, the aggregate link protocol would signal between communication devices 102 and 104 to set up aggregated resource 108 comprising the individual physical links 104a-d. HiGig™ is another load balancing application that utilizes aggregated resources.

According to another embodiment, links 104a-d may couple communications device 102 to two or more other communications devices. For example, links 104a-b may couple communications device 102 to a first device (not shown) whereas links 104c-d couple communications device 102 to a second device (not shown). In this embodiment, it is communications device 102 that maintains the aggregate link 108 comprising the four links 104a-d. Load balancing applications such as, but not limited to, ECMP, may require that links 104a-d couple communications device 102 to two or more other switched as respective nexthops to a destination device.

A goal of the aggregated resource managing operations disclosed herein is to evenly distribute the offered traffic to the individual resources of the resource group over a time period, while minimizing packet misordering and thereby minimizing disruptions to ongoing traffic flows. Misordering of packets may occur, for example, when a traffic flow is changed from one physical link to another physical link and packets from that traffic flow are received at the destination out of order. However, it should be understood that although over time a traffic load comprising numerous traffic flows may be distributed evenly to the individual links of the aggregate link, there may be periods in which one or more of the links have a load that is substantially different in size than the other links.

For example, with four physical links each operating at 10 Gbps, a 20 Gbps offered traffic load may be evenly distributed among the four links by assigning 5 Gbps to each link. However, if another traffic flow is introduced at 3 Gbps, it may be required that the new traffic flow is assigned to only one of the physical links in order to avoid packet misordering that may occur if the traffic is simultaneously distributed over several links of the aggregate. In the event of assigning the new flow to only one of the physical links, the load distribution would not be evenly distributed among all available links because one link will have 8 Gbps whereas the other three links will still have 5 Gbps.

A traffic flow, as the term is used herein, refers to a sequence of data packets that are related. Traffic flows may be defined at various levels of granularity. For example, a traffic flow may be created between a source and a destination (e.g., between a source address and a destination address), or between a program running on a source and a program on a destination (e.g., between source and destination addresses as well as protocol or port number). The addresses may be at the layer 2 media access control layer (MAC layer addresses), network layer (e.g. IP addresses), or other higher layer address. Port numbers or protocol identifiers can identify particular applications. The destination of a traffic flow may be a single node or multiple nodes, such as in multicast traffic flows from a source to multiple destinations.

Communications device 102 includes the capability to control the individual physical links 104a-d or corresponding ports 106a-d in order to turn the individual links on or off, to change a power mode associated with each physical link, and/or otherwise to reassign any of physical links 104a-d and corresponding ports 106a-d to other link aggregates. According to an embodiment, communication device 102 may include the functionality of a standard such as IEEE 802.3az Energy Efficient Ethernet (EEE). EEE includes a low power mode in which some functionality of the individual physical links is disabled to save power when the system is lightly loaded.

Embodiments of the present invention may be directed to load balancing (i.e. distributing the offered traffic load) among the individual physical links of the aggregate link while reducing packet mis-ordering, in a manner that the offered traffic load can be transmitted over the available links of the aggregated resource subsequent to any reconfigurations.

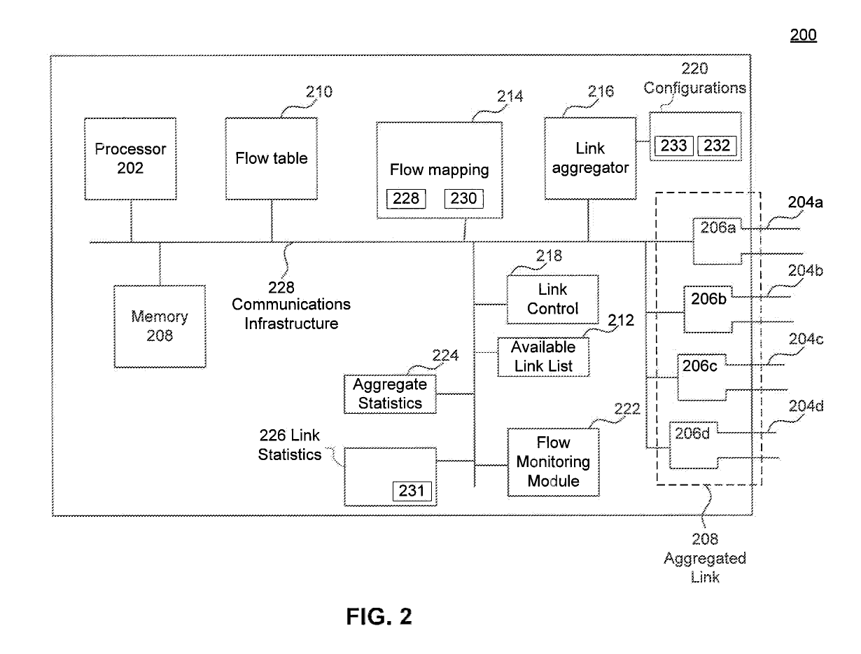

FIG. 2 illustrates an exemplary communications device 200, according to an embodiment of the present invention. Communications device 200 includes a processor 202, a memory 208, physical ports 206a-d corresponding to physical links 204a-d, and a communications infrastructure (also referred to as “bus”) 228.

Processor 202 can include one or more commercially available microprocessors or other processors such as digital signal processors (DSP), application specific integration circuits (ASIC), or field programmable gate arrays (FPGA). Processor 202 executes logic instructions to implement the functionality of or to control the operation of one or more components of communications device 200.

Memory 208 includes a type of memory such as static random access memory (SRAM), dynamic random access memory (DRAM), or the like. Memory 208 can be utilized for storing logic instructions that implement the functionality of one or more components of communications device 200. Memory 208 can also be used, in embodiments, to maintain configuration information, to maintain buffers (such as queues corresponding to each of the physical ports 206a-d), and to maintain various data structures during the operation of communications device 200. In various embodiments, memory 208 can also include a persistent data storage medium such as magnetic disk, optical disk, flash memory, or the like. Such computer-readable storage mediums can be utilized for storing software programs and/or logic instructions that implement the functionality of one or more components of communications device 200.

Communications infrastructure 228 may include one or more interconnected bus structures or other internal interconnection structure that communicatively couple the various modules of communications device 200. A link aggregator module 216 in the communications device 200 includes logic to form, to tear-down, and to manage an aggregated resource 208 which is formed by logically aggregating individual physical links 204a-d. A link control module 218, also in communications device 200, includes logic to, for example, monitor the physical links for activity/inactivity, to turn the physical links on or off, and/or to transition individual links between low power modes and a normal mode. EEE, for example, enables individual links to be configured in low power modes. A configurations module 220 includes configuration parameters, such as load balancing configurations and link configurations for the aggregated resources. Load balancing configurations and link configurations may include parameters defining a desired operating bandwidth for the respective links of an aggregated resource, a threshold bandwidth which when exceeded on a link causes additional links to be configured, a minimum number of links in the aggregated resource that should be active for redundancy purposes, and the like. Configurations module 220 may also include a configured desired number of traffic flows per link 233 in an aggregated resource. According to another embodiment, configurations module can include a register 232 indicating a link to which flows should be reassigned.

An available link list 212 of representing currently active links for each aggregate link may be maintained by link control module 218. For example, available link list 212 may be used to maintain separate lists for each current aggregate link, or to represent the respective aggregate links as separate groups in the same register or set of registers.

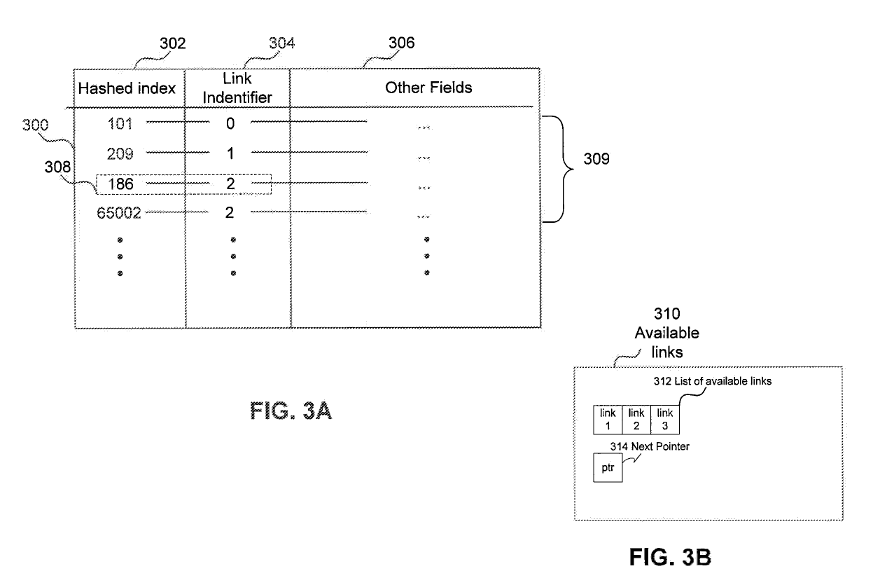

A flow table 210 is configured to maintain information about flows. Specifically, according to an embodiment, flow table 210 includes an entry for each currently active flow indicated by the corresponding flow identifier. A flow table is further described in relation to FIG. 3A below. According to other embodiments, a separate flow table or a separate packet forwarding infrastructure including a separate flow table may be maintained for each application. For example, LAG, ECMP, and HiGig™ may each have its own flow table.

A flow identifier is a numeric or other value that is used to identify one or more flows. According to one embodiment, a flow identifier uniquely identifies a flow. For example, a flow identifier may be based on a source address, destination address, and protocol number or port number from the packet header fields. The combination of the source address, destination address, and protocol or port number, may uniquely identify a data traffic generated between a particular application executing on respectively the source and destination. According to another embodiment, a flow identifier may identify more than one flow. For example, a flow identifier that is based upon the source address and a destination address may represent all flows between the source and the destination, regardless of the application that generates the respective flows.

According to an embodiment, the flow identifier is a 16-bit numeric value. One or more selected fields from a packet header (“header fields”) may be combined in a predetermined manner and the resulting combination may be hashed to generate a hashed flow identifier that corresponds to the flow identifier. For example, a conventional hashing scheme may be used to generate a hashed flow identifier with a value between 0-(2ⁿ−1) by calculating (flow identifier) modulo 2ⁿ. The hashed flow identifier is not required to be dependent on the aggregated resource configuration such as the number of links.

A flow mapping module 214 includes logic to map incoming traffic flows to a physical port 206a-d of the aggregated resource 208. According to an embodiment, flow mapping module 214 can generate a flow identifier (based on predetermined rules, for example) for respective incoming packets and then, if it is a flow identifier for which an outgoing link is not specified, determine to which of the four physical links 204a-d that flow identifier is to be mapped. The mapping may involve mapping from the flow identifier space to a two bit space that maps each flow identifier to exactly one of the four physical links 204a-d. If the flow identifier of the packet matches a flow which has already been assigned to a physical link, then the packet is queued to the corresponding physical port. Flow mapping module 214 may include a link deactivation flow mapping module 228 and a new link activation flow mapping module 230. The former includes logic to perform flow mapping when a link in an aggregated resource is deactivated, whereas the latter includes logic to perform flow mapping when a new link is activated.

A flow monitoring module 222, according to an embodiment, includes logic to monitor flows on respective ones of the physical links 204a-d. The monitoring can include, for example, collecting physical link statistics such as the data rate corresponding to a flow over a predetermined interval, the aggregate data rate for the aggregate link 208, and the time at which the last packet was transmitted or received corresponding to the flow. Physical link statistics, such as the number of flows assigned to respective links 231 and the traffic load on the respective links, can be stored and maintained in memory 208, in registers 226, or other location. Similarly, aggregate link statistics, such as the total number of traffic flows assigned to the aggregated resource and the total traffic load among all active physical links of the aggregate, can be stored and maintained in memory 208, in registers 224, or other location.

FIG. 3A illustrates an exemplary flow table 300 as one embodiment of a flow table 210, that can be used to keep track of the flow assignments to respective physical links. In some embodiments, per flow information such as current statistics fix the respective flows can be maintained in the same table 300. According to an embodiment, flow table 300 includes a column 302 to hold the flow identifier of a flow or an index to which flow identifiers may correspond, and a column 304 to identify the link to which the flow is assigned. According to an embodiment, one or more other fields 306 can also be included in flow table 300. A flow identifier can be formed by one or more header fields of the packets or frames. For example, a combination of header fields, such as, the source address, the destination address, and a port or protocol identifier can form a unique identifier for a particular flow. According to another embodiment, a hashed value of a combination of selected fields is used as the flow identifier. The flow identifier may be the index with which to access the table 300. When a packet is received at the communication device 200, for example, the flow identifier for the packet is determined using one or more header field values. Then, the flow identifier or a hashed value derived from the flow identifier is checked against the flow table 300. If an entry already exists for the particular flow identifier, the packet is mapped to the link indicated in the corresponding row of the flow table 200. If an entry corresponding to the flow identifier is not in the flow table 300 or if the entry corresponding to the flow identifier does not have a mapped link, the flow is mapped to a link using a flow adding method described below, and a new entry is added to the flow table 300 with the flow identifier or an index corresponding to the flow identifier and the link to which it is mapped. The pairing of a flow identifier or hashed flow identifier and a link identifier in an entry in a flow table may be referred to as a mapping 308.

As described above, a communications device such as a switch or router may have a plurality of aggregated resources. According to one embodiment, each aggregated resource will have its own flow table 300 in a separate memory or separate device. According to another embodiment, a multiple aggregated resources share a flow table by grouping entries belonging to respective aggregated resources. For example, entries group 309 of flow table 300 may belong to a first aggregated resource, whereas other groups of links in flow table 300 may be established for other aggregated resources. According to another embodiment, flow table 300 may include a plurality of groups 309 of a fixed number of entries each. The fixed number of entries may correspond to the number of possible unique hashed flow identifiers according to the configurations. The group 309, or the corresponding one of the plurality of aggregated resources in the communications device, for example, may be selected for an incoming flow or incoming packet based on the destination address.

Furthermore, in some embodiments, each load balancing application such as LAG, ECMP, and HiGig™ may be provided with its own one or more flow tables or separate forwarding infrastructure including separate flow tables. Access to an application-specific flow table may be determined based on configurations (e.g. configurations specifying an application based on a source or destination address, or a protocol identifier in the header of a packet) or may be based upon one of the applications being specified in the header or else wherein the packet.

FIG. 3B illustrates an available link list 310, according to an embodiment. Available link list 310 can include a list of available links 312, and a pointer 314 to the next available link. The list of available links 312 may include one entry for each physical link that is currently active, and pointer 314 can be configured to keep track of as to which of the available links the next flow is to be assigned.

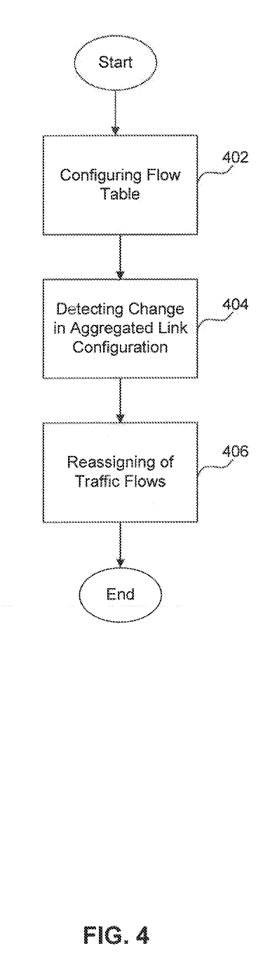

FIG. 4 illustrates a method 400 for managing links in aggregate resources such as an aggregated resource, according to an embodiment. In step 402, a flow table is configured. According to an embodiment, flow table 210 is configured to provide an association between flow identifiers and available links.

According to an embodiment, as illustrated using flow table 300, each entry in the flow table may include a mapping 308 from a hashed flow identifier (or, in some embodiments, a flow identifier) to a link identifier. As described above, each flow identifier or hashed flow identifier may represent one or more flows. The link identifier may represent an active physical link (or port) in an aggregated resource. The link identifier that is listed in the flow table may be the address of a physical link or a logical identifier that maps to a physical link.

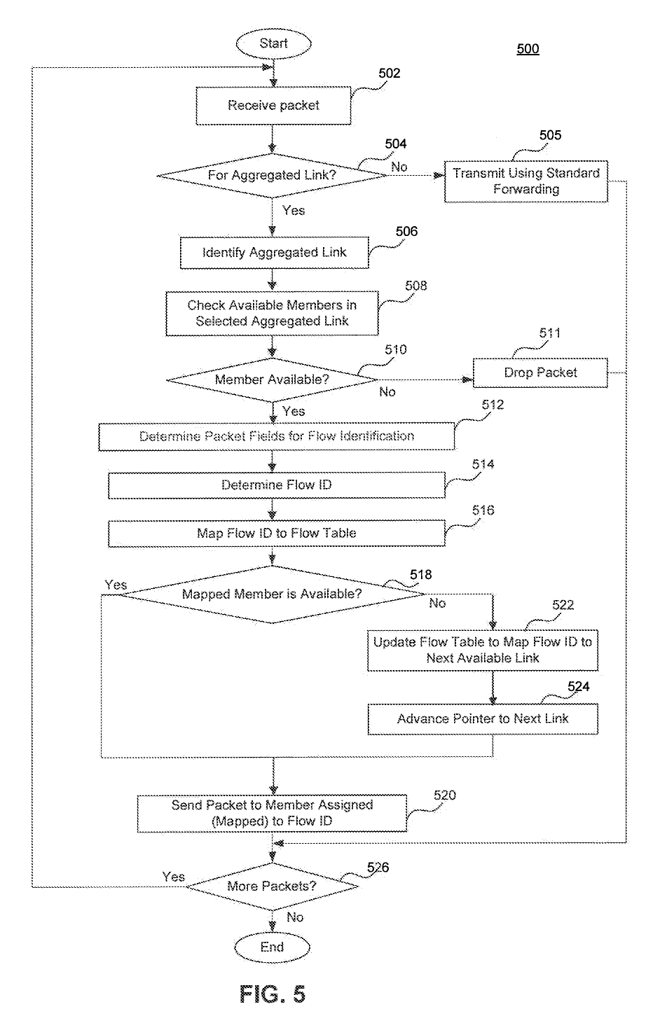

Entries (referred to as “mappings” or “flow mappings”) in flow table 300 can be dynamically configured. Dynamically configuring flow mappings is described below in relation to FIG. 5. Flow table 300 can also include one or more manually configured flow mappings. For example, a network administrator may manually configure one or more flow mappings specifying that traffic flows having a flow identifier based on particular source and destination addresses are to be transmitted over a specific physical link.

In step 404, a change in the aggregated resource configuration is detected. According to an embodiment, the deactivation of a previously active link of the aggregate link may be detected. The deactivation may be due to link failure, nexthop failure, manual configuration by an administrator, or other reason. According to another embodiment, the activation of a previously inactive link or a link that was previously not part of the aggregated resource is detected. The activation may be due to manual addition of a new link to the aggregated resource by an administrator, or the activation of a new link by an automated process.

The detection of changes in the configuration of the aggregated resource may be performed by link control module 218. The detection of a deactivation or activation of a link may be performed by monitoring one or more predetermined registers and/or signals. Upon detecting a change of configuration in the aggregated resource, link control module 218 may add or delete an entry corresponding to the added or deleted link.

In step 406, the traffic flows are assigned and/or reassigned among the set of active links in the aggregated resource. As described above, a goal of the assignment and/or reassignment may be to distribute the traffic flows evenly among the links of the aggregated resource. Another goal may be to reduce the misordering or loss of packets within a data flow due to the changing of the physical link to which the packet is assigned. If a previously active link of the aggregated resource has been deactivated, then the traffic flows previously assigned to that link are reassigned among the remaining active links in the same aggregated resource. If a link has been newly activated, then, according to an embodiment, the traffic flows may be reassigned among all active links including the newly activated link of the aggregated resource so that the distribution is relatively even.

FIG. 5 illustrates a method 500 for configuring a flow table. According to an embodiment, method 500 can be used in performing step 402 described above. In step 502, a packet to be forwarded is received. When more than one packet is available to be forwarded, the next packet to be forwarded may be selected in any order. In some embodiments, the selection of packets may be ordered according to the size of the corresponding flow (e.g. flow with highest bandwidth requirements to lowest) so that the larger flows are assigned first to retain flexibility in evenly distributing the traffic volume among the available links. In other embodiments, packets or traffic flows may be selected in a random order. In another embodiment, each incoming packet may be processed according to method 500 to determine to which traffic flow it belongs to and to determine which link it should be sent out of.

In step 504, a determination is made whether the packet is to egress through an aggregated resource (i.e., aggregated link). According to an embodiment, the determination in step 504 is made by looking up a forwarding table based upon the destination address of the packet. The forwarding table may indicate if an outgoing interface is an aggregated resource. If, in step 504, it is determined that the outgoing interface for the packet is not an aggregated resource, then in step 505 the packet is transmitted over the selected outgoing interface without the use of an aggregated resource, and processing proceeds to step 526 to determine if more packets are available to be forwarded. If, in step 504, it is determined that the outgoing interface is an aggregated resource, processing proceeds to step 506.

In step 506, the aggregated resource on which the packet is to be forwarded is identified. According to an embodiment, the aggregated resource may be specified in the forwarding table as the outgoing interface corresponding to the destination of the packet. According to an embodiment, the identification of the aggregated resource may be performed during the lookup of the forwarding table described in relation to step 504 above.

In step 508, the available members (i.e., available links) in the aggregated resource are identified. For example, the available links (i.e. currently active links in the aggregated resource) of aggregated resource 208 is identified. The current list of available links can, for example, be maintained in available link list 212. According to an embodiment, when initializing a flow table 210, link control module 218 may reset a pointer 314 to point to the first available link in list 312 according to a predetermined ordering as the next available link.

In step 510, it is determined whether the identified members of the aggregated resource are available. According to an embodiment, it is determined whether at least one available link of the aggregated resource is up and available to transmit packets. If there are no available links in the selected aggregated link, then, in step 511, the packet is dropped and processing proceeds to step 526 to determine if more packets are available to be forwarded.

In step 512, one or more fields which are to be used to form a flow identifier of the packet are selected. In this step the fields of the packet for the flow identifier are selected according to predetermined rules. For example, the source address and destination address fields of the packet may be selected.

In step 514, a flow identifier is formed from the one or more packet fields that were identified in the previous step. The selected packet fields may be combined according to predetermined rules to form a flow identifier. The combination of the selected fields may be hashed to generate a hashed flow identifier for the packet. According to an embodiment, as described above, a combination of selected fields may be hashed to yield a 16-bit hashed flow identifier, e.g., a value in the range 0-2¹⁶. One or more traffic flows can have the same hashed flow identifier. Other methods of mapping a flow identifier that is a combination of packet fields to a flow identifier of fewer bits are contemplated within embodiments of the present invention.

In step 516, it is determined whether the hashed flow identifier of the incoming packet has already been mapped to a link. According to an embodiment, flow table 210 is searched for an entry corresponding to the hashed flow identifier of the incoming packet. Any search method may be used. The search method may also be determined according to the organization of the flow table. For example, as described above, the flow table for an aggregated resource may be a table in a fast memory, such as, but not limited to, a static random access memory (SRAM) or content addressable memory (CAM), with a fixed size and having an entry for each of all possible hashed index values (i.e., hashed flow identifier values). Having a fixed size flow table in memory indexed on the hashed flow identifiers, for example, allows direct access to the corresponding entry based upon the hashed flow identifier of the incoming packet.

In step 518, it is determined whether the hashed flow identifier mapped to an available aggregate member.

If a mapping corresponding to the hashed flow identifier of the incoming packet is not found in the flow table, then processing proceeds to step 522. In step 522, a mapping for the incoming hashed flow identifier may be added to the flow table. According to an embodiment, either a mapping 306 with a corresponding index to the hashed flow identifier is found in flow table 300, or a new entry with the hashed flow identifier is added to flow table 300. The mapping for the hashed flow identifier is completed by specifying the next available link as the assigned link. The next available link may be determined based on the available link list 310. According to an embodiment, next pointer 314 in available link list 310 points to an entry in list of available links 312 which corresponds to the next link to which the incoming traffic flow should be assigned. The mapping is updated relating the hashed flow identifier of the incoming packet to the next available link. The next available link list 310, is maintained as an attribute of each aggregated link. According to another embodiment, the next available link list 310 may be maintained may be separately maintained for each of a plurality of applications such as, but not limited to, ECMP, LAG, or HiGig™

In step 524, according to an embodiment, next pointer 314 is updated to point to another available link in the list of available links 312, as the link to be assigned to the next incoming new traffic flow. For example, pointer 314 can be advanced to point to the next entry after the currently selected next link. Processing may then proceed to step 520 to send the incoming packet to the selected link.

If it is determined in step 518 that a mapping corresponding to the hashed flow identifier is found in the flow table, then processing proceeds to step 520. In step 520, the mapping corresponding to the hashed flow identifier is used to determine the aggregate member (i.e., link) to which the incoming packet is to be assigned. The incoming packet is then forwarded to the port corresponding to the determined assigned link for transmission. In step 526, it is determined whether more traffic flows or more incoming packets are to be assigned to a link. If yes, processing proceeds to step 502 and steps 502-526 are repeated for the next packet to be forwarded. Otherwise, method 500 may end.

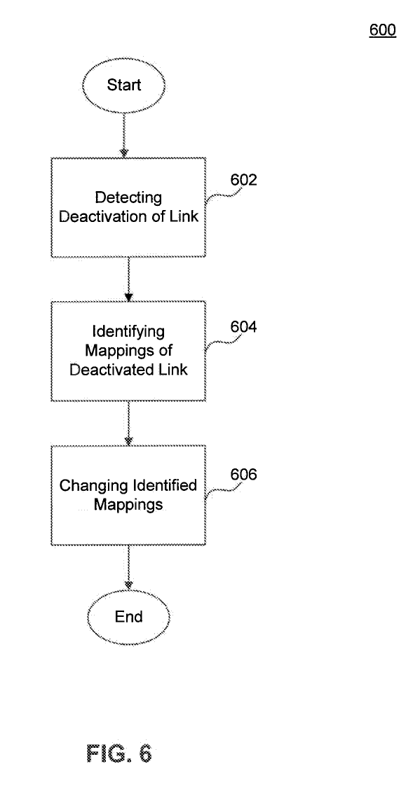

FIG. 6 illustrates a method 600 for managing a deactivation of a previously active link of an aggregate link. According to an embodiment, method 600 may be used in performing step 406 described above. In step 602, a deactivation of a link in the aggregated resource is detected. The detection of a deactivation is described above, for example, with respect to step 404 of method 400.

In step 604, current mappings to the deactivated link are determined. According to an embodiment, flow table 300 is processed to determine mappings in which link identifier field 304 includes the identifier of the deactivated link.

In step 606, the identified mappings that currently refer to the deactivated link are changed (also interchangeably referred to as “reassigned”) to refer to respective active links of the same aggregated resource. The respective identified mappings may be updated by changing the corresponding link identifier field 304 to an active link according to any method of selecting one of the available links for each respective identified mapping. By changing only the flows that are currently assigned to the deactivated link, traffic flows that are on other links of the aggregated resource are shielded from any packet misordering that may occur due to the link deactivation.

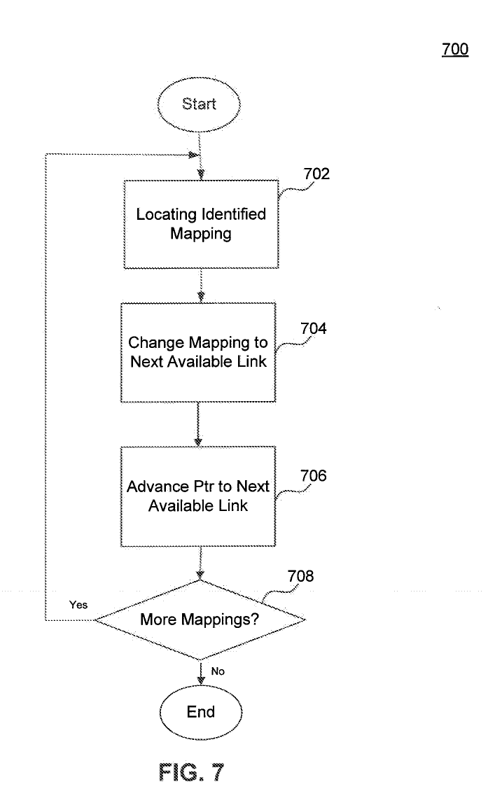

FIG. 7 illustrates a method 700 of updating flow table entries that are currently mapped to a deactivated link. According to an embodiment, method 700 may be used in performing step 606 to reassign the mappings that are currently assigned to the deactivated link. According to an embodiment, steps 702-708 are repeated for each entry of the flow table that is to be updated due to the deactivation of the link. None of the entries in the flow table that are assigned to the other links (i.e. other than the deactivated link) of the aggregated resource are required to be changed, thereby limiting any traffic flow disruption due to packet misordering to the flows on the deactivated link. According to an embodiment, the entries to be updated may be processed or updated in the order of their occurrence in the flow table.

In step 702, one of the mappings to be updated is selected. Mappings may be selected for updating in the order of occurrence in flow table 300.

In step 704, the link identifier field 304 of the selected mapping is updated to refer to the next available link. According to an embodiment, the next available link is specified in available links list 310. Specifically, according to the embodiment, the next available link is determined to be the entry in list of available links 312 to which next pointer 314 is pointing to.

In step 706, after the currently selected mapping is updated, the next pointer 314 is adjusted to point to another available link. Next pointer 314 may be adjusted to point to the next link in sequence in list of available links 312. Adjusting next pointer 314 after each reassignment or after a predetermined number of reassignments of flows is an efficient way of distributing the traffic flows to be reassigned.

In step 708, it is determined whether any further mappings remain to be updated due to the deactivation of the link. If any further mappings remain, then processing proceeds to step 702 to select the next mapping to be updated. Otherwise, method 700 ends and the reassignment of traffic flows that were previously assigned to the deactivated link is completed.

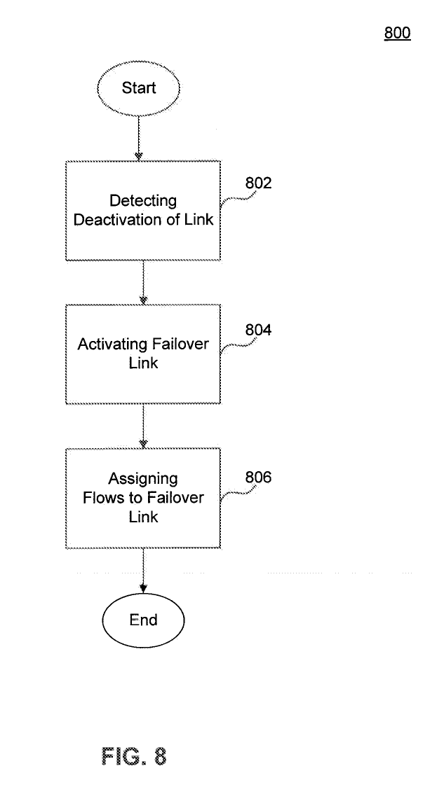

FIG. 8 illustrates a method 800 for managing the reassignment of traffic flows when a link in the aggregated resource is deactivated. Specifically, method 800 illustrates a method for reassignment of the deactivated link's traffic flows when a failover link is activated to replace the deactivated link.

In step 802, a link deactivation is detected, and in step 804 the activation of a link, such as a failover link, is detected. Each aggregated resource, for example, may be preconfigured with one or more failover links that activate immediately upon the failure of a link in the aggregated resource. The detection of the deactivation and the detection of the activation may be based upon monitoring of registers and or predetermined signals. According to an embodiment, link control module 218 detects link deactivations and activations and can trigger further processing required to reconfigure the aggregated resource as necessary.

In step 804, a failover link is activated to replace the deactivated link. According to an embodiment, a failover link may have been configured for one or more of the aggregated resources in a communications device. A failover link may be configured to activate automatically upon the detection of a failure of any active links. According to an embodiment, one or more registers, memory locations, and/or signals may be updated to reflect that the failover link is activated and the address or link identifier of the failover link.

In step 806, traffic flows previously assigned to the deactivated link are reassigned to the newly activated failover link. This reassignment may be performed, for example, by finding the mappings that correspond to the deactivated link in the flow table. Each of the mappings corresponding to the deactivated link is then updated by specifying the identifier for the newly activated failover link in the corresponding link identifier field 304. After the reassignment of each mapping that was previously assigned to the deactivated link, the reassignment is completed.

It should be noted that according to another embodiment, the deactivation of a currently active link and the activation of a failover link in response to the deactivation may occur transparently to the traffic flow mapping process. For example, the newly activated failover link may be configured to be responsive to the same link identifier as the deactivated link.

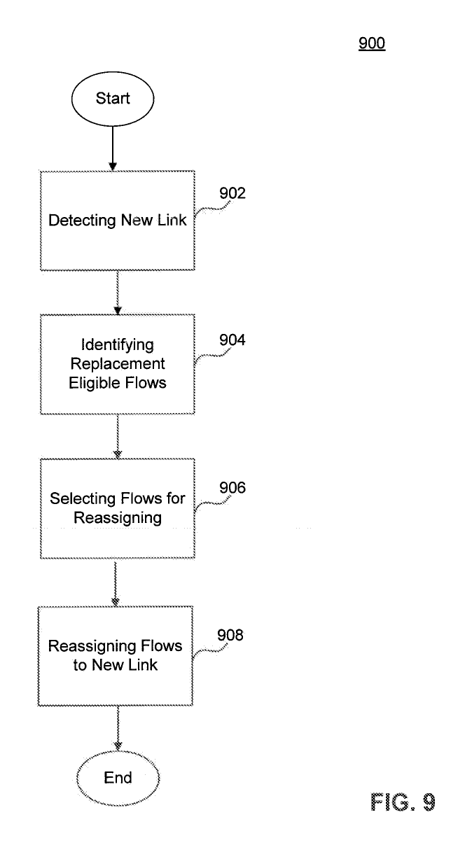

FIG. 9 illustrates a method 900 for managing traffic flows in an aggregated resource when a new link is activated. According to an embodiment, method 900 may be used in performing processing of step 406 of method 400.

In step 902, a new link activation in the aggregated resource is detected. As described above, a new link can be activated due to manual operations by an administrator or due to an automatic activation, for example, by a process to scale the aggregate link to traffic flow demands. The detection of the activation, as described above, may be performed by link control module 218.

In step 904, flows that are eligible to be reassigned to the newly activated link are identified. According to an embodiment, respective mappings in flow table 300 are processed to identify any flows that can be reassigned to another link in the aggregated resource. Eligibility to be reassigned may be determined, for example, based on the number of traffic flows currently assigned to each link.

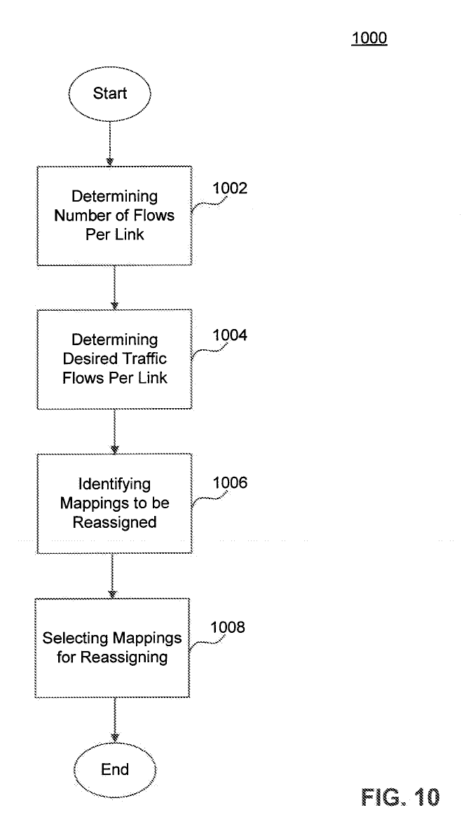

In step 906, flows to be reassigned to other links are selected from the set of reassignment eligible links. The selection may be based upon a probability or other criteria to distribute the traffic flows across all available links in the aggregated resource. The determination of reassignment eligible links and the selection of flows for reassignments are described in further detail below in relation to FIG. 10.

In step 908, the selected links are reassigned. The reassignment can be performed, for example, by replacing the link identifier field 304 of each mapping that was selected to be reassigned with the identifier for the newly activated link. When the reassignment of each of the selected mappings is completed, the traffic flows may be substantially evenly distributed among the available links in the aggregated resource.

FIG. 10 illustrates a method 1000 for selecting traffic flows to be reassigned to a newly activated link. According to an embodiment, method 1000 can be used in performing steps 904-906 described above.

In step 1002, the number of traffic flows currently assigned to each link in the aggregated resource is determined. According to an embodiment, flow monitoring module 222 may perform a scan of flow table 210 to determine the number of entries in the table that has a link identifier field 304 corresponding to each respective link. The number of entries of the flow table 210 that correspond to each link can be saved in link statistics 226, for example, in a set of registers 231 for per link number of flows statistics.

In step 1004, a desired number of flows for each link in the aggregated resource are determined. According to an embodiment, based on a number of traffic flows being currently sent through the aggregated resource and the number of active links in the aggregated resource, a number of traffic flows to be assigned to each link may be determined. For example, each active link may be assigned an equal or nearly equal share of the traffic flows. According to another embodiment, each link may have different desired numbers of traffic flows. For respective links, different numbers of traffic flows may be assigned to links in the same aggregated resource for various reasons, for example, such as individual link capabilities and/or characteristics. The desired number of traffic flows per link may be configured in the one or more registers 232.

In step 1006, flow table 210 may be scanned to determine which entries are eligible to be reassigned to the newly activated link. According to an embodiment, a traffic flow is determined to be eligible for reassignment if it is mapped to a link that has a number of flows currently assigned to it that exceeds a desired number of assigned traffic flows. For each link in the aggregated resource, the corresponding value in the per link number of flows registers 231 can be compared to the corresponding value in the desired per link number of flows registers 232. According to an embodiment, the eligibility of the flow can be recorded during the scan of entries using a field in flow table, such as, an eligibility field in other fields 306 of flow table 300.

In step 1008, flow table 210 may be scanned again to select a number of the flows from those determined to be eligible to be reassigned. A second scan of flow table 210 entries can be performed to make the selection from mappings that have the eligibility field set in flow table. The selection of eligible mappings may be performed iteratively in a per link manner in groups of one or more mappings. In each iteration up to a predetermined number of the eligible mappings may be selected for reassignment, and at the end of the iteration the eligibility of yet unselected flows can be reevaluated after updating the number of currently assigned flows per link 231 for each link. Iterations may continue for a predetermined maximum number of iterations or until mappings are evenly distributed across all available links of the aggregated resource. The selection of mappings from respective links can be performed according to any of several methods.

The selection of eligible links to be reassigned may be performed by distributing the selected mappings across the eligible links, rather than selecting based upon the order of occurrence of mappings in the flow table. By distributing the selected mappings across the eligible links, the mappings are evenly assigned to the links. According to an embodiment, for each eligible flow on a particular link, it may be determined if the mapping should be reassigned by generating a random number and comparing the generated number against a replacement probability. A replacement probability may be determined, for example, for each link based on the number of mappings or flows (such as that indicated in registers 231) that link has beyond the desired number of flows (as indicated in register 232) in the current configuration of the aggregated resource. In another embodiment, mappings may be selected based on a predetermined interval of occurrence in the flow table. For example, if 20 mappings are eligible in a link, and 4 selections are required, then every fifth mapping is selected to be reassigned.

The representative functions of the communications device described herein can be implemented in hardware, software, or some combination thereof. For instance, processes 400-1000 and/or modules shown in FIG. 2 can be implemented using computer processors, computer logic, ASIC, FPGA, DSP, etc., as will be understood by those skilled in the arts based on the discussion given herein. Accordingly, any processor that performs the processing functions described herein is within the scope and spirit of the present invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for managing traffic flows in a communications device, comprising:
configuring a flow table containing a plurality of mappings, wherein each of said mappings specifies a relationship between one of a range of index values and at least one of a plurality of available member resources of an aggregated resource associated with the communications device;
assigning, using the flow table, respective traffic flows to at least one of the plurality of available member resources; and
responsive to a change in the plurality of available member resources, changing the plurality of mappings.

2. The method of claim 1, further comprising:
detecting a deactivation of one of the plurality of available member resources; and
responsive to the deactivation, reassigning traffic flows previously assigned to the deactivated member resource to a plurality of other member resources of the plurality of available member resources.

3. The method of claim 2, wherein the reassigning comprises:
identifying ones of said mappings that correspond to the traffic flows previously assigned to the deactivated member resource; and
changing respective ones of the identified mappings by relating the index value of the mapping with one of the other member resources of the plurality of available member resources.

4. The method of claim 3, wherein the changing step comprises:
assigning ones of the other member resources to respective identified mappings in a round robin manner.

5. The method of claim 1, wherein the assigning step comprises:
determining a flow identifier of a traffic flow;
generating a hashed value based upon the determined flow identifier; and
looking up the flow table using the generated hashed value to thereby identify a mapping including a corresponding member resource.

6. The method of claim 1, wherein the configuring the flow table comprises:
determining a flow identifier of a traffic flow;
generating a hashed value based upon the determined flow identifier;
searching in the flow table for a mapping of the generated hashed value including a corresponding member resource; and
configuring the mapping in the flow table if the searching did not find the mapping.

7. The method of claim 1, wherein the plurality of available member resources form an aggregated resource managed according to a load balancing application.

8. The method of claim 7, wherein the plurality of available member resources form one of a plurality of aggregated resources in the communications device.

9. The method of claim 7, wherein for each said load balancing application a respective flow table is configured.

10. The method of claim 1, further comprising:
detecting a deactivation of one of the plurality of available member resources;
responsive to the deactivation, activating a failover member resource; and
reassigning ones of said mappings previously assigned to the deactivated member resource to the activated failover member resource.

11. The method of claim 1, further comprising:
detecting an activation of a new member resource, wherein the new member resource is added to the plurality of available member resources; and
responsive to the activation, assigning ones of the mappings to the new member resource.

12. The method of claim 11, wherein assigning traffic flows to the new member resource comprises:
identifying replacement eligible traffic flows among traffic flows previously assigned to other ones of the plurality of available member resources; and
reassigning selected ones of the identified replacement eligible traffic flows to the new member resource.

13. The method of claim 12, wherein the identifying replacement eligible traffic flows is based upon a predetermined desired per member resource load distribution amount and a per member resource current load amount.

14. The method of claim 12, wherein the reassigning step comprises:
selecting respective ones of the identified replacement eligible traffic flows to be reassigned;
identifying a mapping in the flow table corresponding to the selected traffic flow; and
changing the assigned member resource in the identified mapping to the new member resource.

15. A system for managing traffic flows of a plurality of available member resources in a communications device, comprising:
a flow table configured to contain a plurality of mappings, wherein each of said mappings specifies a relationship between one of a range of index values and at least one of the plurality of available member resources of an aggregated resource associated with the communications device; and
a traffic flow mapper configured to:
assign, using the flow table, respective traffic flows to at least one of the plurality of available member resources; and
responsive to a change in the plurality of available member resources, changing the plurality of mappings.

16. The system of claim 15, the traffic flow mapper is further configured to:
detect a deactivation of one of the plurality of available member resources; and
responsive to the deactivation, reassign traffic flows previously assigned to the deactivated member resource to a plurality of other member resources of the plurality of available member resources.

17. The system of claim 16, wherein the traffic flow mapper is further configured to reassign by:
identifying ones of said mappings that correspond to the traffic flows previously assigned to the deactivated member resource; and
changing respective ones of the identified mappings by relating the index value of the mapping with one of the other member resources of the plurality of available member resources.

18. The system of claim 15, the traffic flow mapper is further configured to:
detect an activation of a new member resource, wherein the new member resource is added to the plurality of available member resources; and
responsive to the activation, assign traffic flows to the new member resource.

19. A computer readable media storing instructions wherein said instructions, when executed by a processor, are adapted to manage traffic flows of a plurality of available member resources in a communications device with a method comprising:
configuring a flow table containing a plurality of mappings, wherein each of said mappings specifies a relationship between one of a range of index values and at least one of the plurality of available member resources of an aggregated resource;
assigning, using the flow table, respective traffic flows to at least one of the plurality of available member resources; and
responsive to a change in the plurality of available member resources, changing the plurality of mappings.

20. The computer readable media of claim 19, the method further comprising:
detecting a deactivation of one of the plurality of available member resources; and
responsive to the deactivation, reassigning traffic flows previously assigned to the deactivated member resource to a plurality of other member resources of the plurality of available member resources.
